(19) United States
(12) Patent Application Publication
(10) Pub. No.: US 2003/0222121 A1
(43) Pub. Date: Dec. 4, 2003

(54) Die casting sprue system

(76) Inventors: Morris Taylor Murray, Briar Hill (AU); Matthew Alan Cope, Somerville (AU)

Correspondence Address: John C. Kerins, MILES & STOCKBRIDGE P.C., Suite 500, 1751 Pinnacle Drive, McLean, VA, 22102-3833, US

(21) Appl. No.: 10/304,788

(22) Filed: Nov. 27, 2002

Related U.S. Application Data
(63) Continuation of application No. PCT/AU01/00595, filed on May 22, 2001.

(30) Foreign Application Priority Data
May 29, 2000 (AU) PQ7804

(51) Int. Cl. B23K 1/00

(52) U.S. Cl. 228/101

(57) ABSTRACT

A sprue system, for use in a pressure casting machine, such as a machine for hot chamber die casting, or for producing castings from a thixotropic alloy, or a cold chamber die casting machine, is provided, which includes a plurality of sprue dies which form a sprue housing, or bush, through which a sprue region extends longitudinally between inlet and outlet ends of the housing or bush. The sprue dies are relatively movable laterally with respect to the longitudinal extent of the sprue region, between an advanced position in which the sprue dies form the housing or bush and a retracted relative position.

This invention relates to a sprue system for use in pressure casting machinery, such as hot chamber die casting machines or machines for producing castings from thixotropic alloy, and some forms of cold chamber casting machines. The invention also relates to a die assembly for a machine of either of these types, which system has a sprue system of the invention, and a casting machine having that assembly. The invention further relates to an improved process for producing die castings by use of a casting machine of the invention and improved castings produced by that process.

In the well known hot chamber die casting machine, a die cavity is defined by a multi-part die which is mounted adjacent to a vessel in which molten alloy is maintained at a suitable temperature for casting. Above the vessel, there is a shot cylinder which has a plunger extending into a component shaped like and referred to as a goose-neck within the molten metal. The plunger, when actuated by the cylinder, forces molten alloy through a nozzle of, or associated with, the gooseneck. From the nozzle, the alloy passes through a sprue region and, via a runner and gate system, into the die cavity. Upon completion of filling of the cavity and sufficient solidification of the cast alloy, the plunger movement is reversed to cause still molten alloy in the flow path to the sprue region to be drawn back towards the vessel.

The conventional sprue region for such apparatus has two functions. The first of these functions is to transport and distribute molten metal from the nozzle to the runners feeding the die cavity or die cavities. The second function is to provide a solidification zone from which the molten metal is to be drawn back to leave in the sprue region solidified alloy, referred to as a sprue, following solidification of the alloy from the die cavity, back along the sprue region to the solidification zone. Thus, alloy at the solidification zone in the sprue region is to be the last to solidify. T he sprue region can have a simple frusto-conical shape which is solid or, by use of a sprue post (sometimes referred to as a sprue pin or sprue spreader), which is hollow. Alternatively, the runners can be machined into the sprue post.

Difficulty in achieving each of the functions of the sprue region necessitates adoption of a number of compromises. For optimum transport of molten alloy from the nozzle to the gates, it is best that the alloy is kept molten at a substantially uniform temperature. However, for the alloy subsequently to be solidified at a solidification zone through the interface between nozzle and the sprue, it is necessary to actively cool the sprue post, as well as a bush defining the outer periphery of the sprue region, while the nozzle needs to be heated.

The conventional sprue region is designed so that the solidified sprue metal can be removed from the die with the casting. For this, the sprue region is designed as a cone shape with the larger end nearer to the casting and the smaller end at the nozzle. However, this presents a problem in satisfying thermal requirements, and the problem is most severe if a solid sprue is to be produced (that is, the sprue is formed without use of a sprue post). The largest volume of sprue metal is near the base of the sprue and the smallest volume of sprue metal is adjacent to the nozzle. Hence, if no cooling is supplied to the sprue bush, the sprue region would solidify initially near the nozzle and solidification then would proceed towards the die cavity. This would be unacceptable as solidification shrinkage would occur adjacent to the base of the sprue, with the likely consequence of localised fracture of nearly solidifying or newly solidified metal. There then would be a risk of sprue metal being left in the sprue region, rather than removed with the casting, necessitating its manual removal prior to the next casting cycle. Thus, solidification must be forced to occur in the reverse direction, that is, towards the nozzle, by the use of aggressive cooling. It is common for the sprue post and sprue bush to be maintained at close to 100° C. whereas the rest of the die is maintained at about 120° C. to 200° C. for optimum casting quality for each of zinc, lead and magnesium alloys. This drastically chills the molten metal as it passes through the sprue region, thus reducing the possible quality of the casting.

The present invention arises from our work in relation to die casting of magnesium alloys, as detailed in International patent application PCT/AU98/00987. That application discloses that some casting characteristics of magnesium alloys distinguish those alloys from other die casting alloys. Among other benefits, the differing casting characteristics of magnesium alloys enable a very substantial improvement in the casting yield; that is, the percentage ratio of casting weight to total shot weight. Thus, the weight of metal which needs to be recycled and reprocessed is able to be substantially reduced, with a resultant reduction in production costs.

The object of the invention is to provide a sprue system which better utilises the casting characteristics of magnesium alloys and thereby enables further enhancement of casting yield. However, it is found that the sprue system of the invention also has utility in the casting of other alloys. Thus, while it was not an object per se of the invention to overcome the problems of the prior art in satisfying thermal requirements, those problems can be alleviated with at least some embodiments of the invention for casting other alloys.

According to the invention there is provided a sprue system for use in a pressure casting machine, such as a machine for hot chamber die casting, or for producing castings from thixotropic alloy, or for some forms of cold chamber die casting machines, wherein the system includes a plurality of sprue dies which form a sprue housing, or bush, through which a sprue region extends longitudinally between inlet and outlet ends thereof; and wherein the sprue dies are relatively movable laterally with respect to the longitudinal extent of the sprue region, between an advanced position in which the sprue dies form the housing or bush and a retracted relative position.

With the sprue dies in their advanced position, the housing of the sprue system is adapted to be held under clamping pressure prevailing during a casting cycle, such as a hot chamber die casting cycle. When so clamped, the sprue dies are held against relative movement, that is between the gooseneck nozzle and the die cavity where casting is by use of a hot chamber die casting machine. Thus, molten metal is able to be forced through the sprue region during a casting cycle. On completion of a casting cycle, and release of the clamping pressure, the sprue dies are able to be moved to their retracted relative position.

The housing preferably is formed from two sprue dies. In that case, one sprue die preferably is substantially the mirror image of the other, while each defines substantially one half of the sprue region. More than two sprue dies can be used, although any benefit resulting from using at least three sprue dies generally is offset by added complexity in providing for relative movement of the sprue dies.

Each sprue die may be in the form of a slide which is mounted for reversible lateral movement. The lateral movement may be substantially at right angles to the longitudinal extent of the sprue region. However, the sprue dies may move at an angle to the longitudinal extent of the sprue region such that there is a sufficient lateral component of the movement which is substantially at right angles to the longitudinal extent of the sprue region.

It is preferred that each sprue die comprises a slide. However, other arrangements are possible even if more complex. Thus, for example, each sprue die may be mounted for movement on a spiral path such that they move between their advanced and retracted positions in a similar manner to elements of an iris. Alternatively, each sprue die may comprise a finger element of a collet form of device.

The tapered form of the sprue region used in conventional practice is necessary, in part, in order to enable a casting to be removed. That is, the resultant sprue metal is correspondingly tapered, enabling it to be extracted when the die is opened and the casting is ejected. A somewhat similar taper can characterise the sprue region of the sprue system of the present invention, in that the sprue dies can define the sprue region as a tapered sprue region which increases in cross-section in a direction towards the inlet end. However, in the invention, the sprue region is freed of a need to be of such form as a necessity. Thus, the sprue region can be designed with other objectives in mind, such as to achieve cooling through the sprue region to a solidification zone without the need for aggressive cooling, or to minimise the volume of the sprue region and hence, of sprue metal.

In a simple form of the sprue system, the sprue dies when in their advanced position may define a sprue region of substantially uniform cross-section of an area suitable for the metal to be cast. Thus each sprue die, where formed for providing a part of the sprue region, may simply be machined to define a groove which, for a sprue system of two dies, is of semi circular cross-section. However, with such simple form of sprue system it is preferred that the housing has a counter-sink at the end of the sprue region which is to accommodate the nozzle of the gooseneck.

The sprue region defined by the sprue dies may be of any suitable cross-section, whether circular or non-circular. Also, the sprue region may vary in cross-section between its inlet or upstream end to its outlet or downstream end, with respect to metal flow from a pressurising source of alloy to the die cavity. In a first form, the region may taper, such as frusto-conically, with its larger end nearer to the die cavity, such as at or adjacent to the outlet end of the sprue region. This form of taper is similar to that of the prior art discussed above but, in the present invention, that form can be particularly beneficial when making a magnesium alloy casting by direct injection. In accordance with the disclosure of PCT/AU98/00987, the sprue region may function as a direct injection runner with the smaller outlet end being of a cross-section resulting in a magnesium alloy flow velocity therethrough of from about 140 to about 165 m·s⁻¹, preferably about 150 m·s⁻¹. The flow velocity then decreases along the length of the sprue region and within the die cavity.

In a second form, the sprue region may be frusto-conical but with its larger end nearer to the source of alloy, such as at or adjacent to the inlet end of the sprue region. That is, in terms of taper, the arrangement may be the opposite of that used in prior art practice for hot chamber die casting. This arrangement also is suitable for making a magnesium alloy casting by direct injection. In accordance with the disclosure of PCT/AU98/00987, the sprue region again functions as a direct injection runner, with the smaller outlet end being of a cross-section resulting in a magnesium alloy flow velocity therethrough of from about 140 to about 165 m·s⁻¹, again preferably about 150 m·s⁻¹, and with the flow velocity decreasing further downstream on entering the die cavity.

In the second form, it is preferred that the smallest cross-section of the frusto-conical sprue region is spaced a short distance from the end of that region which is nearer to the die cavity. Between that end and the die cavity, there may be a short end length of the sprue region which does not decrease further, but which most preferably increases slightly, in cross-section. This results in a waist or channel in solidified sprue metal which, as illustrated in more detail later herein, facilitates breaking of the sprue metal to leave a casting with which it is associated with a smaller effective sprue.

In a third form, the sprue region may have a larger cross-section intermediate of its ends and taper frusto-conically from that larger cross-section towards each end. In that form, the taper towards the gooseneck nozzle may continue to the end of the sprue region in an arrangement providing for a solidification zone at the junction between the nozzle and the sprue region. The frusto-conical taper towards the end of the sprue region nearer to the die cavity may continue to a minimum cross-section adjacent to that end, with there being a short end length of the sprue region as described from the second form. Sprue metal solidified through to the solidification zone_enables its separation from the nozzle, with the casting, following retraction of the plunger to draw back still molten alloy. Also, the sprue metal is able to be broken at the waist or channel, resulting in the casting having only a small effective sprue thereon, with a major part of the sprue metal forming a separated plug or pellet.

In a fourth form, the sprue region is as in any of the first, second and third forms. However, it comprises only a downstream part of a passage defined by the sprue dies. A solidification zone is defined at the junction between the downstream and upstream parts of the passage and, to achieve this, the upstream part of the passage is of larger cross-section than the adjacent end of the sprue region. Thus, the upstream part of the passage provides a continuation, beyond the gooseneck nozzle, of the section of the overall molten alloy flow path in which the alloy is kept molten for withdrawal.

As indicated at the outset, the sprue dies which form the housing of the sprue system of the invention are relatively movable laterally with respect to the longitudinal extent of the sprue region. This is necessary where the form of the sprue region is such that solidified sprue metal otherwise would preclude extraction of the sprue metal from the sprue region. However, the ability of the sprue dies to move can be used to advantage where the sprue region is of a form such that solidified sprue metal therein is able to be broken. That is, at least one sprue die can be used to apply a force to the sprue metal, causing it to break or shear. Thus, with the sprue dies released for retraction from their advanced position to their retracted position, and their retraction at least initiated, and with a casting still partially constrained by other tool parts defining the die cavity, one of the sprue dies can be moved back to, and preferably slightly beyond, its normal advanced position so as to impact with the sprue metal and cause the sprue metal to break or shear at the casting or at the waist or channel. Alternatively, the sprue dies may move in union in a given lateral direction to shear or break the sprue metal at a waist or channel. The movement in unison can be prior to retraction of the sprue dies being initiated, or after a small initial retraction.

In a conventional sprue region, the molten metal flow velocity into the melt end of the region usually is about 10 to 30 m·s⁻¹. Such a velocity level is still appropriate for use of the present invention for all zinc, lead and magnesium die casting alloys unless, in the case of magnesium alloys, use is to be made of the disclosure of PCT/AU98/00987. Where that disclosure is to be used in the present invention, the flow velocity for the magnesium alloy is to obtain a level of from about 140 to about 165 m·s⁻¹, preferably about 150 m·s⁻¹, followed by a decrease in flow velocity. These velocities, where achieved in a sprue region, necessitate a sprue region cross-sectional area which is two orders of magnitude smaller than in a sprue region of conventional cross-sectional area. Thus the sprue region, and the volume of sprue metal solidified in it, is able to be very small relative to conventional practice. This is one factor able to contribute to the very high casting yield obtainable with the invention of PCT/AU98/00987.

The present invention further provides a die assembly, for a machine for hot chamber die casting, or for producing castings from thixotropic alloy, or a cold chamber die casting machine, wherein the die assembly includes a die tool which at least partially defines at least one die cavity, and a sprue system which includes a plurality of sprue dies which form a sprue housing, or bush, through which a sprue region extends longitudinally between inlet and outlet ends thereof to define part of a path for receiving alloy from a source of supply for flow into the at least one die cavity; and wherein the sprue dies are relatively movable laterally with respect to the longitudinal extent of the sprue region, between an advanced position in which the sprue dies form the housing or bush and a retracted relative position.

In a die assembly according to the invention, the arrangement can vary. One important factor influencing this is whether the sprue region is to provide for direct injection or is to feed the die cavity via at least one runner and gate.

Where the sprue region is to provide for direct injection feed to the die cavity, an arrangement well suited to producing magnesium alloys by the invention of PCT/AU98/00987, each sprue die preferably has a surface at which the outlet end of the sprue region opens and which in part defines the die cavity. That is, the sprue dies co-operate with other die components to form and define the die cavity. Thus, the sprue dies may form part of or comprise a cover die half, or they may form part of or comprise a die cavity insert of a cover die half, with the cover die half in each case being co-operable with an ejection die half. Conversely, the sprue dies may form part of or comprise the ejection die half or a die cavity insert of the ejection die half.

For a die assembly in which the sprue region is to feed the die cavity via a runner and gate, the arrangement is more amenable to the die assembly being a multiple cavity die. However this simply results in alloy flow through the sprue region feeding to each of two or more die cavities via at least one respective runner and gate, and it is sufficient to consider the arrangement as it applies to only one of the die cavities. In such arrangement, the sprue dies are separated from the die cavity by a section of the assembly which defines the gate and at least part of the runner. The runner may be defined fully by that section or it may be defined in part by one or each sprue die. Thus the sprue dies may form part of a cover die half, with the cover die half being co-operable with the ejection die half to define the die cavity. Conversely, the sprue dies may form part of the ejection die half.

The present invention further provides a machine pressure casting, such as a machine for hot chamber casting, or for producing castings from thixotropic alloy, or a cold chamber die casting machine, wherein the machine includes a die assembly, clamping means associated with the die assembly, and pressurised supply means for feeding molten alloy to at least one die cavity defined by the die assembly; wherein the die assembly includes a die tool which at least partially defines the at least one die cavity, and a sprue system which includes a plurality of sprue dies which form a sprue housing, or bush, through which a sprue region extends longitudinally between inlet and outlet ends thereof to define part of a path for receiving alloy from the source of supply for flow into the at least one die cavity; and wherein the sprue dies are relatively movable laterally with respect to the lon7gitudinal extent of the sprue region, between an advanced position in which the sprue dies form the housing or bush and a retracted relative position; and wherein, with the sprue dies in their advanced position, the clamping means secures the sprue dies in relation to the die tool whereby alloy is able to flow from the supply means, through the sprue region and then to the at least one die cavity.

In one form of the casting machine according to the invention, each die half is mounted on a respective platen, with the die halves held together by means of a toggle clamp powered by a pneumatic or hydraulic ram. In the case of a hot chamber die casting machine, the supply means may be a shot cylinder extending into a vessel in which molten alloy is maintained, with the shot cylinder operable to force pressurised alloy through a gooseneck for filling the die cavity.

A hot chamber die casting machine according to the invention preferably is of conventional in-line form. That is, the gooseneck nozzle and sprue region preferably feed the alloy to the die cavity along a line substantially parallel to forces clamping the die halves together. However, the sprue dies are movable between their advanced and retracted positions in directions substantially at right angles to the clamping forces. Also, when the sprue dies are in their advanced position in preparation for and during casting, the clamping forces most preferably act to secure the sprue dies in that position. Thus, prior to the sprue dies moving to their retracted position, it is necessary to release the clamping force in order to enable that movement. The release of the clamping force initially may be such that the die halves still are held together, but with the sprue dies sufficiently freed for movement in a manner minimising the risk of damage to surfaces in sliding contact.

However, the invention also extends to casting machines other than hot chamber die casting machines. Specifically, the machine according to the invention may be one for producing castings from a thixotropic alloy. Thus, the machine may be of the type in which a semi-solid charge of alloy of suitable microstructure is positioned in a shot chamber and then injected by a piston into a die cavity. The machine may be one which uses a semi-solid alloy charge produced by cooling liquid alloy, or it may be one using a billet of alloy heated so as to achieve the semi-solid condition. Alternatively it may be a machine which uses a charge of preformed pellets or chips, of appropriate alloy, which is fed into a heating chamber, and which then is driven by screw, or other means, through a nozzle and into the die cavity. Also, the invention extends to some forms of cold chamber die casting machines, specifically those able to operate with use of the sprue system of the invention or the die assembly of the invention.

In a die casting or other pressure casting process according to the invention the sprue dies are moved to and clamped in their advanced position prior to the commencement of casting. The sprue dies are kept in that position until the casting is complete and the cast alloy has solidified sufficiently in the die cavity and from that cavity back along the sprue region to a solidification zone. The sprue dies then are freed for movement to their retracted position, with such movement then initiated to an extent enabling relative movement between the sprue dies and the casting in a direction enabling solidified sprue metal to be withdrawn from the sprue region.

In one preferred form of the process, movement of one of the sprue dies towards its retracted position is reversed to enable a part, preferably a major part, of the sprue metal to be broken away or sheared from the casting at a designed breaking zone. For this, the one sprue die is moved back to and preferably beyond its advanced position so as to impact against and break the sprue metal at that zone. The casting then is removed from the casting machine, prior to the machine being made ready for a next casting cycle.

In another preferred form of the process, the sprue dies are movable in unison in a given lateral direction so as to shear or break the sprue metal therebetween from a casting. The movement in unison may be before movement of the sprue dies to their retracted position has commenced, or after a small initial part of that movement. The casting may be removed from the die prior to the movement of the sprue dies to their retracted position starting or restarting, with that movement allowing removal of the sheared or broken off sprue metal.

The sprue dies may be movable by actuators operable to move those dies between their advanced and retracted positions. The sprue dies preferably interfit with a guideway defined by an adjacent component of the machine. Conversely, such component may interfit with a respective guideway defined by each sprue die. Each actuator may be a pneumatic or hydraulic press which, preferably, extends outwardly at a respective side of the machine, substantially at right angles to the line of action of the clamping means of the machine. However other forms of actuators can be used such as, for example, actuators providing movement by a rack and pinion arrangement.

Reference now is made to the accompanying drawings, in which:

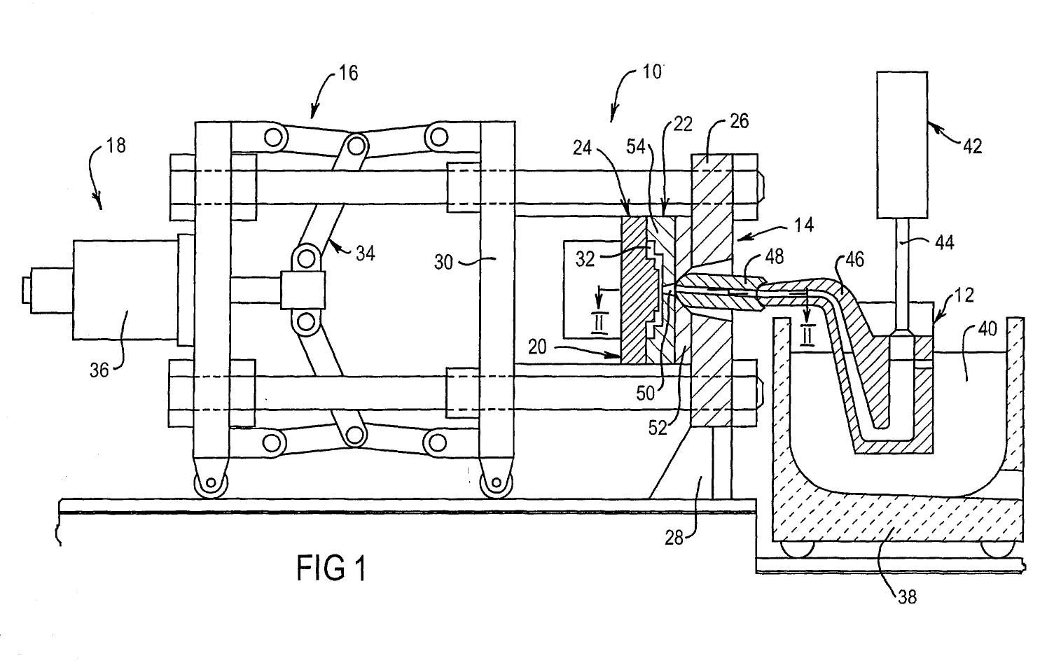

FIG. 1 is a side elevational view, partly in section, of a hot chamber die casting machine according to the present invention;

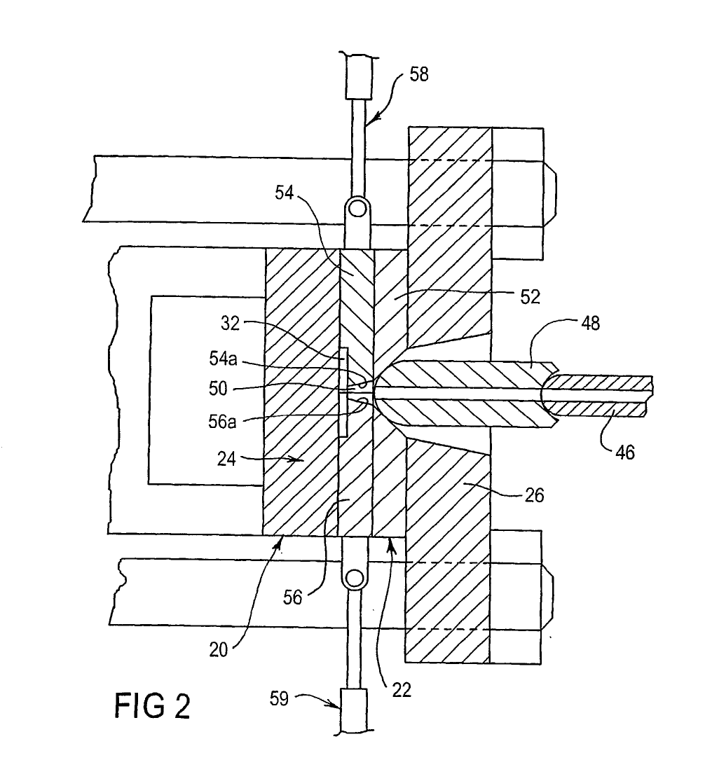

FIG. 2 is a sectional view taken on line II to II of FIG. 1;

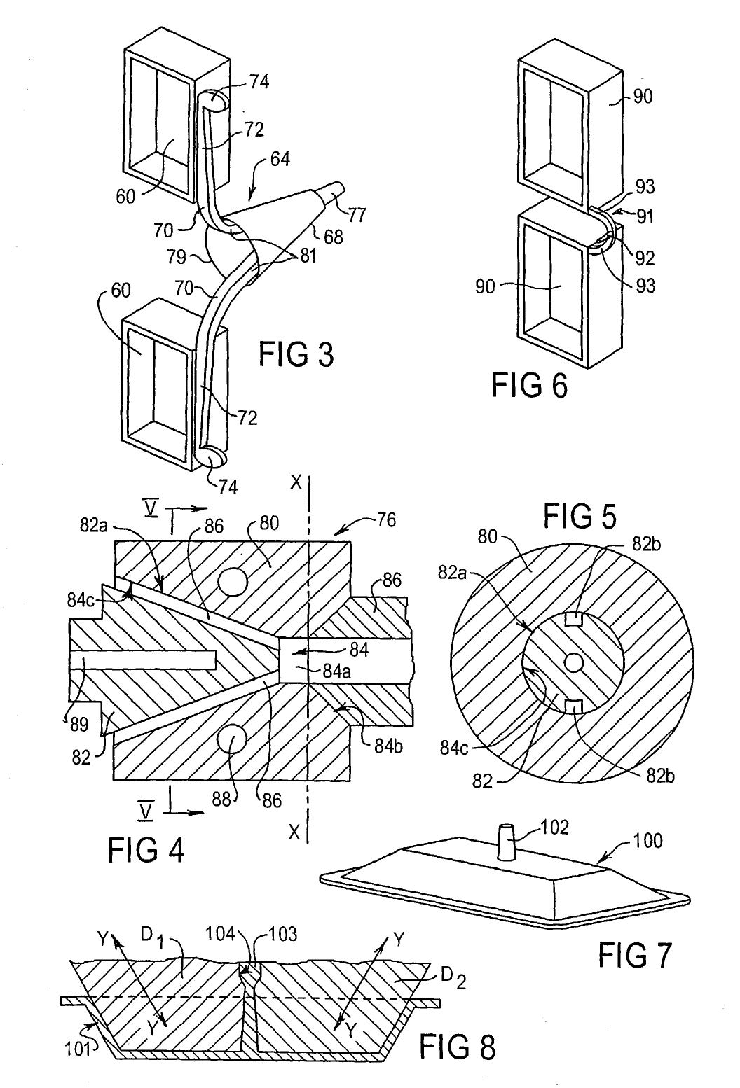

FIG. 3 is a perspective view of castings as produced by a conventional die casting machine;

FIG. 4 shows components for defining a sprue region for castings in FIG. 3;

FIG. 5 is a sectional view, taken on line V-V of FIG. 4;

FIG. 6 is a perspective representation of a casting corresponding to that of FIG. 3, but as produced by the present invention;

FIG. 7 is a perspective representation of another form of casting as produced by the present invention;

FIG. 8 shows a variant on the casting of FIG. 7;

FIG. 9 is a sectional representation of one form of sprue region according to the invention;

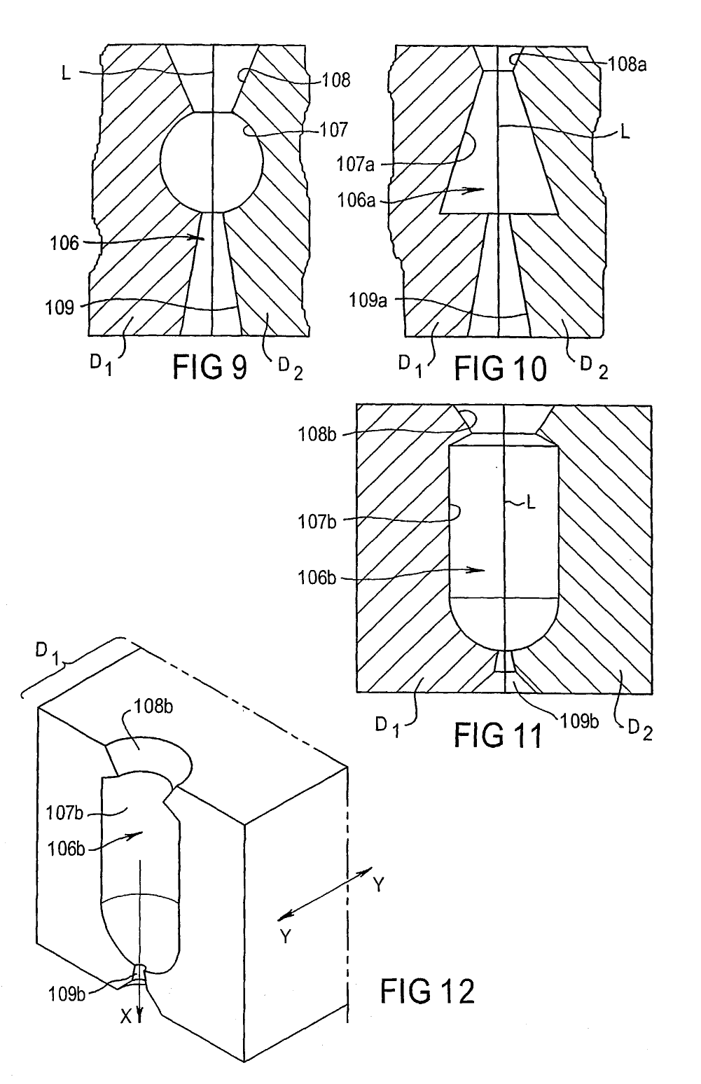

FIG. 10 corresponds to FIG. 9, but shows another form of sprue region;

FIG. 11 also corresponds to FIG. 9, but shows a still further form of sprue region;

FIG. 12 is a perspective representation of the sprue region defining end of a die of the arrangement of FIG. 11;

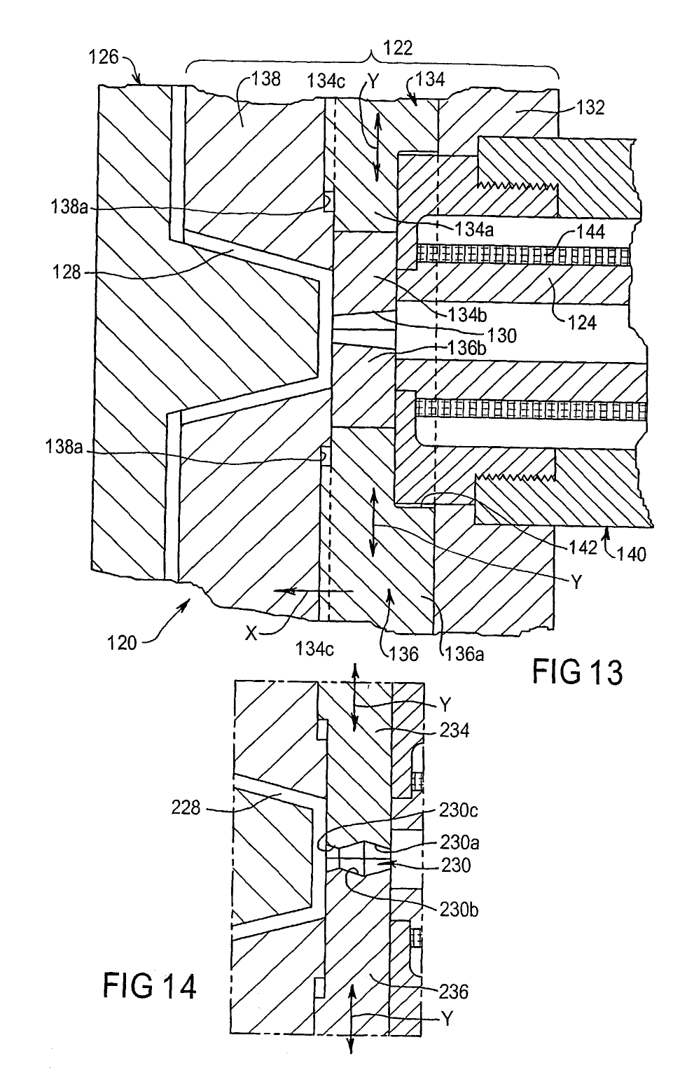

FIG. 13 is a sectional view of a die assembly according to an embodiment of the invention;

FIG. 14 is a sectional view of an alternative form of sprue die for use in the assembly of FIG. 13; and

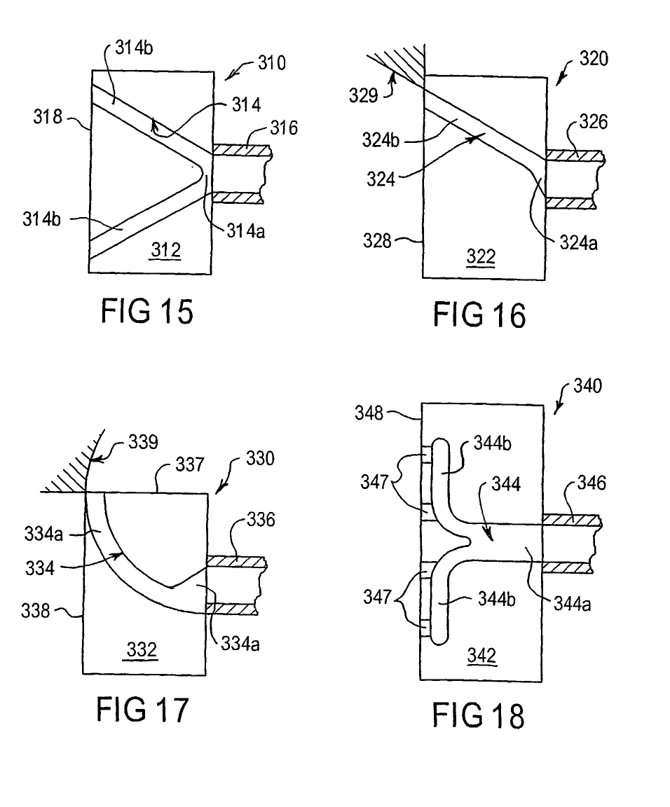

FIGS. 15 to 18 each shows an end elevation of a sprue die according to a respective further alternative form.

With reference to FIGS. 1 and 2, there is shown a high pressure die casting machine 10. This has an in-line arrangement of a molten metal supply station 12, a casting station 14, a locking mechanism 16 and a closing mechanism 18. The general detail of and mode of operation with machine 10 will be readily understood by those skilled in the art, and description largely will be limited to a broad overview.

Casting station 14 includes a die assembly 20 which has a fixed, cover die half 22 and a movable ejection die half 24. The fixed die half 22 is secured to fixed platen 26 secured on support base 28. The die half 24, for which the ejection mechanism is not shown, is mounted on movable platen 30. The die half 24 is able to be clamped against die half 22 to define a die cavity 32, or moved away from die half 22, under the action of the toggle clamp 34 of mechanism 16 and the pneumatic actuator 36 of mechanism 18.

Station 12 includes a furnace 38 in which a suitable alloy 40 is kept molten at an appropriate casting temperature. A shot cylinder 42 is mounted above furnace 38 and has a plunger 44 which extends into a gooseneck shaped component 46 positioned in the molten alloy 40. A nozzle 48, which projects through the fixed platen 26, provides communication between the outer end of gooseneck 46 and a sprue region 50 of die half 22. Region 50 communicates with die cavity 32. Thus, actuation of cylinder 42, to drive plunger 44 further into gooseneck 46, causes molten alloy to be forced under pressure through the gooseneck 46, the nozzle 48 and the sprue region 50, thereby filling die cavity 32. This, of course, assumes that die halves 22, 24 are clamped together to close cavity 32 for filling. However, on completion of filling and solidification of metal in cavity 32 and back along the flow-path to a solidification zone through the interface between sprue region 50 and nozzle 48, cylinder 42 is activated to raise plunger 44 and thereby withdraw molten alloy upstream from that plane.

The preceding description of FIGS. 1 and 2 relates to detail of prior art machines and their operation. However machine 10 is in accordance with the present invention.

The fixed die half 22 has a backing structure 52 on which there is slidably mounted a laterally opposed pair of sprue dies 54 and 56. Only sprue die 54 is visible in FIG. 1. This is because in the condition shown, sprue dies 54, 56 sealing abut at faces above and below sprue region 50 on a vertical plane through the longitudinal centre line of machine 10. However, the dies 54, 56 are laterally movable in opposite directions from the advanced position of the condition shown, to a retracted position.

Each of sprue dies 54, 56 is mounted in relation to structure 52 by structure 52 defining a laterally extending guideway or track with which the dies 54, 56 interfit (for example, in the manner described later herein with reference to FIG. 13). In order to move dies 54, 56 laterally along the guideway or track, each of dies 54, 56 is connected to a respective actuator 58, 59, each shown as comprising a pneumatic or hydraulic actuator or piston and cylinder device.

Sprue region 50 is of frusto-conical form and, in the arrangement shown, it has its smaller end nearer to the die cavity 32 while, at its larger end, it is in communication with the bore of nozzle 48. Each half of region 50 is defined by a respective groove 54a, 56a formed in each die 54, 56. Thus, for casting, it is necessary that actuators 58, 59 are extended so as to hold the abutting faces of dies 54, 56 firmly in sealing relationship. After this relationship is achieved by operation of actuators 58, 59, it is made even more secure by the die halves 22, 24 being forced and locked together by operation of actuators 36 and clamps 34.

For ejection of a casting produced in die cavity 32, it is necessary for clamp 34 to be unlocked and for die half 24 to be withdrawn sufficiently from die half 22 by operation of actuator 36. However, after an initial slight separation of halves 22, 24 which is necessary to free the sprue dies 54, 56 for lateral movement, and commencement of action of the ejection mechanism of half 24, movement of dies 54, 56 to their retracted position needs to commence. This is because of the re-entrant form of sprue metal solidified in sprue region 50, since the sprue will be held in region 50 until there is sufficient retraction of dies 54, 56.

FIG. 3 shows castings 60 as produced by a conventional hot chamber die casting machine having a multiple die cavity. The form of the components comprising castings 60 is incidental. However, each casting has a rectangular box-like form and as ejected from the casting machine, the castings 60 are held together by runner and sprue metal 64. This metal 64 includes sprue metal 68 which solidified in a frusto-conical sprue region of opposite taper to that shown in FIGS. 1 and 2; a short strip 70 to each plate 64 which solidified in a respective main runner; a tapered strip 72 along the side of each plate 64 which solidified in a respective tapered tangential runner; and a disc 74 at the end of each strip 72 which solidified in a respective “shock absorber” at the end of each tangential runner. As will be appreciated, the castings 60 need to be separated from the runner metal strips 72 and from any flash. However, the weight of metal comprising the sprue metal 68, the strips 70 and 72 and the discs 74 is substantial relative to the weight of the metal comprising the four castings 60. Thus, the casting yield is relatively low, in this instance about 50%.

FIGS. 4 and 5 illustrate part of a sprue region 76 suitable for producing castings 60 as in FIG. 3. Thus region 76 is one applicable to a conventional hot chamber die casting machine rather than a machine according to the present invention. Also, in region 76, the components giving rise to strips 70 and 72 and discs 74 are not shown. Rather, there is shown the components for producing sprue metal 68.

Components for defining the sprue region 76 of FIGS. 4 and 5 comprise a sprue bush 80 mountable in relation to a fixed die half, and a sprue post 82 mountable in relation to a movable die half. The bush 80 defines a bore 84 which, from a short intermediate portion 84a, tapers outwardly at one end to provide a seat 84b engaged by the bevelled outlet end of a nozzle 86. The bore 84 also tapers outwardly from portion 84a to define a main frusto-conical surface 84c. Post 82 has a tapered external surface 82a which is substantially complementary to and provides a seal with surface 84c, except at grooves, 82b formed in surface 82a. Each groove 82b is covered by surface 84c of bush 80 to define a respective sprue runner 86.

In the arrangement of FIGS. 4 and 5, a thermal energy balance is achieved by strong cooling of sprue bush 80 and sprue post 82, and by heating of nozzle 86. For the cooling bush 80 and post 82, each is provided with a respective channel 88 and 89 through which cooling water is able to be circulated, while heating of nozzle 86 can be by suitable use of gas burners or of an electric heating element. The thermal energy balance is directed to achieving solidification, on completion of filling of the die cavities, which proceeds from those cavities and back along the sprue runners to a solidification zone which is transverse to the axis of bush 80 and is at the interface between bush 80 and the outlet end of nozzle 86. The zone may be perpendicular to the drawing of FIG. 4 and is represented by the line X-X.

The specific arrangement shown in FIGS. 4 and 5 results in sprue metal 68 of FIG. 3 including a short stub 77 of metal which solidified in portion 84a of bore 84 of sprue bush 80. Also, even though the surface 82a of post 82 is substantially complementary to surface 84c of bush 80. allowance has to be made for thermal expansion and the need to avoid post 82 becoming locked in bush 80. Thus, sprue metal 68 comprises a thin-walled frusto-conical shell 79 and, within shell 79, sprue runner metal strip 81 which forms in each sprue runner 86. While not shown in FIGS. 4 and 5, region 76 includes means which defines runners in which each strip 70 forms as a continuation of a respective runner strip 81.

FIG. 6 shows the form of castings 90, similar to castings 60 shown in FIG. 3, but as produced by the present invention, using a die casting machine as in FIGS. 1 and 2. The castings 90 are held together by a runner and sprue metal 91 which includes a small sprue 92 and, from sprue 92, a respective small runner 93 extending to a convenient location on the edge of each casting 90. As shown, the sprue 92 extends in the opposite direction to sprue 68 in the arrangement of FIG. 3, but this is simply to allow for the lateral movement required for the sprue dies of machine 10 of FIGS. 1 and 2. As will be evident from a comparison with FIG. 3, the quantity of runner and sprue metal is very small, enabling a very substantially enhanced casting yield. At least with the casting of magnesium by the invention of PCT/AU98/00987, the casting yield can be higher than about 95%.

FIG. 7 shows a casting of a dish 100 similar to that shown in FIGS. 10 and 11 of the above mentioned International patent application PCT/AU98/00987. As in that application, dish 100 is well suited to high pressure die casting from a magnesium alloy, using a hot chamber machine as in FIGS. 1 and 2 and a die assembly providing for direct injection.

The dish 100, as cast, has associated therewith only sprue metal 102. The dish is of a substantially uniform, thin-walled construction throughout, with a wall thickness of about 2 mm. As is evident from the sprue 102, the dish 100 was cast by flow of magnesium alloy into the die cavity direct from a sprue region communicating with the die cavity at a single point located centrally with respect to what was to become the basal wall of the dish. However, the sprue projects from the lower surface of the basal wall of the dish rather than the upper surface of that wall as in FIGS. 10 and 11 of PCT/AU98/00987. This difference is to facilitate lateral movement, after solidification of cast alloy, of sprue dies which defined therebetween the sprue region for sprue 102 and which provided respective parts of a surface of the die cavity against which the lower surface of the basal wall was to form.

The sprue 102 tapers in the opposite direction to sprue region 50 of the die assembly of FIGS. 1 and 2. However, if required, the sprue 102 need not taper at all, or it may taper to provide its smaller end at the lower surface of the basal wall of dish 100, or it may be of more complex form. However, regardless of its form, the sprue is able to be such as to substantially enhance the casting yield. For some other castings, this applies regardless of the alloy used, but significantly greater enhancement of that yield is possible with magnesium alloys. For the casting comprising dish 100, use of an alloy other than a magnesium alloy is not likely to be possible with the direct injection alloy feed arrangement shown.

FIG. 8 is a sectional view of a dish 101 as in FIG. 7, but shown in relation to sprue dies for its production using a different die system to that used to produce dish 100 of FIG. 7. In the case of dish 100, the sprue dies used define a surface of the die cavity against which the lower surface of the basal wall of dish 100 is formed. Thus, sprue 102 of dish 100 projects down from that lower surface. However, in dish 101, sprue 103 projects up from the upper surface of the basal wall of the dish; that is, sprue 103 is within the dish as cast. Thus, the sprue dies D(1) and D(2), which define the sprue region 104 in which sprue 103 solidifies, also define internal surfaces of the die cavity in which dish 101 is cast. Thus, the dies D(1) and D(2) comprise angled slides which are movable in the direction of respective arrows Y-Y. That is, dies D(1) and D(2) simultaneously move both laterally and longitudinally with respect to sprue region 104 and with respect to alloy flow through region 104. In the specific example illustrated, arrows Y-Y are substantially parallel to the flared side walls of dish 101, while the frusto-conical sections of sprue region 104 are angled such that sprue 103 does not impede retraction of dies D(1) and D(2).

FIGS. 9 to 11 show alternative forms of sprue region able to be used with the present invention. In each case, there is a partial representation of sprue dies D(1) and D(2), with line L in each case representing a plane on which the dies abut to each side of the sprue region (most conveniently above and below that region) when the dies are in the advanced position for casting. Also in each case, the upper end of the sprue region as shown is flared outwardly for sealing engagement with the outlet end of a gooseneck nozzle. Thus, it is at the lower end of each sprue region that it communicates with a die cavity, either directly or via a runner/gate system.

The sprue region 106 of FIG. 9 has an enlarged, somewhat spherical mid-portion 107 below the flared end 108 at which it is engageable with a gooseneck nozzle. From portion 107 to its other end, region 106 has a taper frusto-conically outwardly tapered portion 109. Solidification of alloy back from the die cavity is able to proceed along portion 109 to a solidification zone through the junction of portions 109 and 107. If the solidification stops at or just short of that zone, sprue metal in portion 109 would be able to be withdrawn without moving sprue dies D(1) and D(2) to their retracted position. However, such movement of dies D(1), D(2) would assist withdrawal of the sprue metal, while it would be necessary if solidification extended into region 107.

Similar considerations apply to the arrangement of FIG. 10 in which parts corresponding to those of FIG. 9 have the same reference plus “a”. In this case, the mid-portion 107a of sprue region 106a is frusto-conical, rather than spherical, and tapers in the same direction as its portion 109a. Again the solidification zone is intended to be at the junction of portions 109a and 107a.

In FIG. 11, parts corresponding to those of FIG. 9 have the same reference numeral plus “b”. In this instance the mid-portion 107b of sprue region 106b is of overall cylindrical form but has a hemi-spherical end through which it communicates with portion 109b. Also, the solidification zone is intended to be beyond portion 109b, intermediate the ends of portion 107b. As a consequence, movement of dies D(1) and D(2) towards their retracted position is necessary for withdrawal of the solidified sprue metal from sprue region 106b, due to the waist formed in that metal as a consequence of the constricted junction between portions 109b and 107b.

Typically, with the arrangement of FIG. 11, the solidification zone will be sufficiently beyond portion 109b of the sprue region 106b for the proportion of sprue metal solidified in portion 109b to be small. In such case, it is preferred that, after initial movement of sprue dies D(1) and D(2) towards their retracted position, one of the dies is returned to and most preferably moved beyond the advanced position. The arrangement preferably is such that the one die impacts against the sprue metal, to cause the larger part to break off and to leave on the casting only the sprue metal that solidified in relatively small end portion 109b. Alternatively, the sprue dies D(1), D(2) may move in unison to shear off the larger part of the sprue metal.

FIG. 12 shows a perspective view of the inner end of the sprue die D(1) of FIG. 11. This highlights that the solidification zone does not have to be the smallest cross-section for sprue region 106b (of which only one half is shown). Since the dies D(1), D(2) move oppositely in directions shown by arrows Y-Y, release of the sprue metal in the direction of arrow X is able to be achieved. Conventional extraction in the direction of arrow X requires that the sprue metal has a continuous taper increasing in that direction. Also, the required control for cooling can be substantially reduced since the solidification can proceed to a zone of larger cross-sectional area (a more natural place to stop solidification) and over a reasonably large distance. Thus, design constraints for the sprue region are able to be reduced, enabling more flexibility. Such form of sprue region is particularly suited for the casting of magnesium alloys by the method disclosed in the above-mentioned International patent application PCT/AU98/00987.

As indicated, instead of the sprue dies, such as dies D(1), D(2) in each of FIGS. 9 to 11, separating to enable extraction of the casting and the sprue as one section, the sprue dies can be moved in unison in the same direction, prior to their movement for die opening. This would shear the sprue off the casting and enable the casting only to be ejected. Subsequently in the process the sprue dies would open and eject the sprue metal. Thus, a trimming press could be done away with and this would reduce the cost as well as the required area for a casting machine and trim press.

In each of FIGS. 9 to 11, the sprue region is shown as being of circular transverse cross-section. However this is not necessary, and they can be of other suitable cross-sections, for example elliptical, square or hexagonal.

The sprue dies of the invention allow for a much shorter sprue region, thus improving the overall casting yield. One way this is able to be achieved is by increasing the diameter of the sprue region to within a short distance from the casting. The relatively large volume of molten alloy in the larger diameter section of the sprue region is able to be left uncooled and hence naturally remain in the flowable condition, thus being easily drawn back into the gooseneck through the nozzle when the shot cylinder plunger is retracted.

Also one of the major problems with hot chamber sprue regions is that, in order for the molten alloy metal to flow back through the nozzle and gooseneck during retraction of the shot cylinder plunger, a vent for air must be produced. Otherwise, a vacuum is produced and the molten alloy stays in the nozzle. The alloy which stays in the nozzle can solidify and either be sufficient to block the nozzle or, on subsequent shots, build up until the nozzle is blocked. With the present invention the sprue dies can be open slightly during retraction of the plunger and thus provide an easily controlled venting position.

FIG. 13 is a sectional view of part of a die assembly 120 according to the present invention for use in producing a complex casting, such as of the form of casting shown in FIG. 15 of PCT/AU98/00987. As shown, the assembly 120 has a fixed die half 122 in engagement with a gooseneck nozzle 124, and a movable die half 126. During casing, molten alloy received from nozzle 124 is able to be injected, via a sprue region 130, into a die cavity 128 defined by die halves 122, 126.

The fixed die half 122 has a stationary backing plate 132 which is connected to a fixed platen (not shown). Die half 122 also has sprue dies 134 and 136 which define sprue region 130, and a front plate 138 which is spaced from plate 132 by dies 134, 136. As shown, the nozzle 124 is located within a sleeve assembly 140 by which it is mounted in an opening 142 through plate 132. Within sleeve assembly 140, an electric heating element 144 is provided around nozzle 124 to enable molten alloy with nozzle 124 to be maintained at a suitable temperature.

Each of sprue dies 134 and 136 has a respective carrier plate 134a and 136a and, secured at an inner edge of its plate, a respective sprue region defining insert 134b and 136b. The arrangement enables use of tool steel for the inserts 134b and 136b and a less expensive steel for the carrier plates 134a and 136a. Also, it enables replacement of inserts 134b, 136b.

FIG. 13 shows the die assembly 120 in a view corresponding to that of FIG. 2. Each sprue die 134 and 136 is movable in the directions of the arrows Y from their advanced position illustrated to the retracted position. The dies 134, 136 are guided in this movement by each having a spline coupling 146 with plate 138, which extends in the direction of movement. Each coupling 136 is defined by at least one elongate key 134c, 136c on each die and a complementary groove or keyway 138a formed in plate 138.

The sprue dies 134, 136 when in their advanced position define a circular recess 148 in which the end of sleeve assembly 140 is received with slight clearance. The arrangement is such that, with the die halves 122, 126 clamped together, the sprue dies 134, 136 are clamped securely between plates 132, 138, while inserts 134b, 136b are clamped securely against the end of nozzle 124. Thus, dies 134, 136 are securely held in their advanced position, with sprue region 130 in line with the bore of nozzle 124.

On completion of filling of die cavity 128, solidification of alloy in that cavity is continued back along sprue region 130 to a solidification zone at the interface between inserts 134b, 136b and nozzle 124. The shot cylinder (not shown) then is retracted to withdraw molten alloy in nozzle 124. Action then is able to proceed for release of the casting from die cavity 128. For this, the clamping pressure acting on the die halves 122 and 126 is released in an initial stage which enables sprue dies 134 and 136 to move with plate 138 away from backing plate 132. The resultant spacing of dies 134, 136 from plate 132 need not be great, such as from a few millimeters up to about 15 mm, as it primarily is to free dies 134, 136 for movement to their retracted position thereby releasing sprue metal solidified in die region 130.

FIG. 14 shows an alternative form of sprue region suitable for use in the arrangement of FIG. 13. Corresponding parts have the same reference numeral plus 100. However the principal difference warranting attention is the form of the sprue region 230. As shown, region 230 is defined by sprue dies 234 and 236 each formed integrally of a suitable tool steel. The region 230 has a maximum cross-section intermediate its ends from which it tapers on each axial direction to define inlet portion 230a which tapers outwardly in the alloy flow direction for casting, and an outlet portion 230b with tapers inwardly in that direction. However, portion 230b ends short of the end at which region 230 communicates with the die cavity, and is followed by a terminal portion 230c which again tapers outwardly in the flow direction for casting. Portion 230c has a small volume relative to either of portions 230a and 230b, while the waist between it and portion 230b is such that solidified sprue metal can be broken or sheared to leave only the metal solidified in portion remaining on the casting. The breaking may be achieved by one of the sprue dies 234, 236 returning to, and most preferably beyond, its advanced position to impact against the sprue metal or by dies 234, 236 before separating, moving in unison to shear the sprue metal from its casting. As with other embodiments, there may be some movement of the sprue metal axially of the sprue region 230 whereby a larger diameter section of the sprue metal is engaged by a part of one die at which a smaller diameter section of the region 230 is defined.

FIG. 15 shows one sprue die 310 of an opposed pair. The die 310 is illustrated in end elevation to show its end face 312 which, in use, is opposed to and abuts against the corresponding face of the other die of its pair. Thus, sprue die 310 has a longitudinal extent disposed at right angles its face 312 and it is movable between its advanced and retracted positions in a direction at right angles to the plane of FIG. 15.

Face 312 of sprue die 310 has been machined to provide a V-shaped groove system 314 which comprises one half of a sprue region defined by the opposed dies when in their advanced position. Groove system 314 has an enlarged inlet end 314a at which it is able to be in communication with a molten alloy supply nozzle depicted schematically at 316. From end 314a, system 314 has diverging arms 314b, each for forming a sprue runner for a common or respective die cavity. With the opposed dies in their advanced position, a respective gate may be defined at the end of each arm 314b, or each arm may lead to a respective main runner. Thus, the surface 318 of die may form a die cavity surface or it may be spaced from the die cavity by a further tool part.

FIG. 16 is similar to FIG. 15 and corresponding parts have the same reference numeral plus 10. As shown, sprue die 320 differs in that the system 314 formed in its face 312 has only a single arm 314b diverging from the line of its inlet end 324a. In the arrangement of FIG. 16, the surface 328 defines part of a die cavity to which a runner defined by arms 324b of the opposed dies opens for direct injection. As shown, the arm 324b is parallel to a surface 329 of an adjacent die tool part, such that injected alloy is able to flow across surface 329.

FIG. 17 is similar to FIG. 16 and corresponding parts have the same reference numeral plus 10. In this case, arm 334b of system 334 is arcuate and its end remote from inlet end 334a, in the orientation shown, is at a top surface 337 rather than at a side surface 328. It is surface 337 which defines part of a die cavity and the arcuate form of arm 334b corresponds substantially to a curved surface 339 defined by an adjacent tool part which also defines part of the die cavity. Thus, injected alloy is able to maintain a curved path in its flow across surface 339.

FIG. 18 shows a variant on the arrangement of FIG. 15 and corresponding parts have the same reference numeral plus 30. With sprue die 340, the inlet end 344a of groove system 344 is somewhat longer. Also the diverging arms 344b are bent to define arcuate portions curving oppositely from end 344a, and a respective linear portion extending parallel to surface 348. The linear portion of each arm 344b communicates with surface 348 via a pair of gates 347 such that each arm can provide two inlets to a respective die cavity or to a common die cavity.

FIGS. 15 to 18 illustrate the design flexibility permitted by use of the sprue dies of the invention. The sprue region is able to be shaped and directed as required to meet the needs for a given casting. Also, the sprue dies are relatively inexpensive to produce, enable a significant reduction in capital costs, particularly for a short run production life.

The sprue system of the invention is particularly well suited to a direct injection form of casting. In this, the sprue region defined by the sprue system is able to communicate directly with a die cavity or with multiple die cavities. In this regard, the flexibility of design illustrated by FIGS. 15 to 18 is such that erosion of die tools and of sprue/runner systems is able to be minimised, overcoming a major disadvantage of previous attempts at producing quality castings by direct injection. In the latter regard, it is to be noted that the ASM Handbook, Chapter 15, entitled “Casting” indicates that, as recently as its April 1996 third printing, the process of direct injection was still under development.

Finally, it is to be understood that various other modifications and/or alterations may be made without departing from the spirit of the present invention as outlined herein.

1. A sprue system for use in a pressure casting machine, such as a machine for hot chamber die casting, or for producing castings from thixotropic alloy, or a cold chamber die casting machine, wherein the system includes a plurality of sprue dies which form a sprue housing, or bush, through which a sprue region extends longitudinally between inlet and outlet ends thereof; and wherein the sprue dies are relatively movable laterally with respect to the longitudinal extent of the sprue region, between an advanced position in which the sprue dies form the housing or bush and a retracted relative position.

2. The sprue system of claim 1 wherein, with the sprue dies in their advanced position, the housing is adapted to be held under clamping pressure prevailing during a hot chamber die casting cycle.

3. The sprue system of claim 1 or claim 2, wherein the system has two sprue dies which together form the sprue housing.

4. The system of claim 3, wherein one of the sprue dies is substantially a mirror image of the other with each sprue die defining substantially one half of the sprue region.

5. The sprue system of claim 1 or claim 2, wherein the system has more than two sprue dies which together form the sprue housing.

6. The sprue system of any one of claims 1 to 5, wherein each sprue die is in the form of a slide which is mounted for reversible lateral movement substantially at right angles to the longitudinal extent of the sprue region.

7. The sprue system of any one of claims 1 to 5, wherein each sprue die is mounted for movement at an angle to the longitudinal extent of the sprue region such that there is a sufficient lateral component of the movement substantially at right angles to the longitudinal extent of the sprue region for providing sufficient separation between the sprue dies when in the retracted position.

8. The sprue system of any one of claims 1 to 5, wherein each sprue die is mounted for movement on a spiral path between the advanced and retracted positions.

9. The sprue system of any one of claims 1 to 8, wherein the sprue dies define the sprue region as a tapered sprue region which increases in cross-section in a direction towards the inlet end.

10. The sprue system of any one of claims 1 to 8, wherein the sprue dies define the sprue region as a tapered sprue region which, over at least an outlet part of the longitudinal extent of the sprue region increases in cross-section in a direction towards the outlet end.

11. The sprue system of any one of claims 1 to 10, wherein the sprue region formed by the sprue dies is of circular cross-section.

12. The sprue system of any one of claims 1 to 11, wherein the sprue region varies in cross-section between inlet and outlet ends thereof.

13. The sprue system of claim 12, wherein the cross-section of the sprue region decreases from the inlet end to a minimum cross-section spaced from the outlet end.

14. The sprue system of claim 13, wherein after the minimum cross-section, the sprue region increases in cross-section to the outlet end.

15. The sprue system of any one of claims 1 to 8, wherein the sprue region has a larger cross-section at a location intermediate its ends and decreases in cross-section from said location towards each end.

16. The sprue system of claim 15, wherein the decrease in cross-section from said location towards each end provides a respective frusto-conical section of the sprue region.

17. The sprue system of claim 15 or claim 16, wherein the decrease in cross-section from said location towards the outlet end of the sprue region ends at a minimum cross-section adjacent to the outlet end.

18. The sprue system of claim 17, wherein the sprue region increases in cross-section from said minimum cross-section to the outlet end.

19. The sprue system of any one of claims 1 to 18, wherein the sprue region comprises a down stream portion, with reference to the intended direction of metal flow, of a passage defined by the sprue dies, with the passage upstream of the inlet end of the sprue region being of larger cross-section than the sprue region at the inlet end.

20. The sprue system of any one of claims 1 to 19, wherein at least one of the sprue dies has a range of movement in directions extending between its advanced and retracted positions, for applying a force acting to break or shear sprue metal solidified therein.

21. The sprue system of claim 20, wherein one sprue die has said range of movement and is moveable beyond its advanced position, away from its retracted position, for applying said force, and then moveable to its retracted position.

22. The sprue system according to claim 21, wherein each said sprue dies initially retracts slightly towards its retracted position prior to said one die moving beyond its advanced position for applying said force.

23. The sprue system according to claim 21, wherein there are two sprue dies and the two sprue dies move in unison during movement of the one sprue die beyond its advance position, after which each sprue die moves to its respective retracted position.

24. The sprue system according to any one of claims 1 to 23, further including actuator means for moving the sprue dies between the advanced and retracted positions.

25. The sprue system according to claim 24, wherein the actuator means comprises a respective actuator for each sprue die.

26. The sprue system according to claim 25, wherein each actuator is a pneumatic or hydraulic actuator.

27. The sprue system according to claim 24, wherein each actuator is a piston and cylinder device.

28. The sprue system according to any one of claims 1 to 27, wherein each of the sprue dies is adapted to be mounted in relation to a fixed structure by a guideway or track along which the sprue dies are moveable between the advanced and retracted position.

29. A die assembly, for a pressure casting machine, such as a machine for hot chamber die casting, or for producing castings from thixotropic alloy, or a cold chamber die casting machine, wherein the die assembly includes a die tool which at least partially defines at least one die cavity, and a sprue system which includes a plurality of sprue dies which form a sprue housing, or bush, through which a sprue region extends longitudinally between inlet and outlet ends thereof to define part of a path for receiving alloy from a source of supply for flow into the at least one die cavity; and wherein the sprue dies are relatively movable laterally with respect to the longitudinal extent of the sprue region, between an advanced position in which the sprue dies form the housing or bush and a retracted relative position.

30. The die assembly of claim 29, wherein each sprue die has a surface at which, with the sprue dies in the advanced position, the sprue region opens to a single die cavity which is partly defined by the die tool and which also is partly defined by said surface of each sprue die, whereby alloy flow into the die cavity is by direct injection feed.

31. The die assembly of claim 30, wherein the assembly includes a cover die half and an ejection die half with said die halves co-operable to define the die cavity, and wherein the sprue dies form at least part of one of the die halves.

32. The die assembly of claim 29, wherein the sprue region provides communication with a die cavity defined by the die tool via a runner and gate system, with the sprue dies separated from the die cavity by a section of the assembly which defines the gate and at least part of the runner for the die cavity.

33. The die assembly of claim 32, wherein the runner is defined in part by at least one of the sprue dies.

34. The die assembly of claim 33, wherein the sprue dies form part of one of a cover die half and an ejection die half of the die tool.

35. The die assembly of any one of claims 32 to 34, wherein the die tool defines a plurality of die cavities with each of which the sprue region provides communication via the runner and gate system.

36. The die assembly of any one of claims 29 to 35, wherein the sprue system is in accordance with any one of claims 2 to 28.

37. A machine pressure casting, such as a machine for hot chamber casting, or for producing castings from thixotropic alloy, or a cold chamber die casting machine, wherein the machine includes a die assembly, clamping means associated with the die assembly, and pressurised supply means for feeding molten alloy to at least one die cavity defined by the die assembly; wherein the die assembly includes a die tool which at least partially defines the at least one die cavity, and a sprue system which includes a plurality of sprue dies which form a sprue housing, or bush, through which a sprue region extends longitudinally between inlet and outlet ends thereof to define part of a path for receiving alloy from the source of supply for flow into the at least one die cavity; and wherein the sprue dies are relatively movable laterally with respect to the longitudinal extent of the sprue region, between an advanced position in which the sprue dies form the housing or bush and a retracted relative position; and wherein, with the sprue dies in their advanced position, the clamping means secures the sprue dies in relation to the die tool whereby alloy is able to flow from the supply means, through the sprue region and then to the at least one die cavity.

38. The machine of claim 37, wherein the die assembly is in accordance with any one of claims 29 to 36.

39. A pressure casting process using a machine according to claim 37 or claim 38, wherein the sprue dies are moved to their advanced position, and then retained in the advanced position by operation of the clamping means prior to the commencement of casting; alloy then is caused to flow from the supply means, through the sprue region, to fill the at least one die cavity; and, following solidification of alloy sufficiently in the at least one die cavity and back along the sprue region to a solidification zone, the clamping means are released to free the sprue dies and the sprue dies are moved to their retracted position for release of cast metal.

40. The process of claim 39, wherein one of the sprue dies, before moving to its retracted position, moves beyond its advanced position so as to impact against and break sprue metal at a designed breaking zone.

41. The process of claim 39, wherein prior to moving to their retracted position the sprue dies are moved in unison in a given lateral direction to thereby shear ore break sprue metal therebetween from a casting.
